(19) United States
(12) Patent Application Publication
(10) Pub. No.: US 2002/0062725 A1
(43) Pub. Date: May 30, 2002

(54) Cutting tool

(76) Inventor: Paul Whitely, Tustin, CA (US)

Correspondence Address: LAW OFFICES OF DENNIS W. BEECH, 19900 Beach Blvd., Suite C-2, Huntington Beach, CA, 92648, US

(21) Appl. No.: 09/800,695

(22) Filed: Mar. 7, 2001

Related U.S. Application Data
(63) Continuation-in-part of application No. 09/330,573, filed on Jun. 11, 1999, now abandoned.

(51) Int. Cl. B26D 3/06

(52) U.S. Cl. 83/875

(57) ABSTRACT

The cutting tool is a rotational blade with radially extending arms on which cutting teeth are attached. The rotational blade is normally a metal material and a common material for the cutting teeth is carbide. The arms and cutting teeth have mating key projections and key grooves to align the teeth when mounted on the arms and to provide structural support for the cutting teeth for the cutting forces encountered. A fastener such as a screw passing through the cutting tooth and threaded into the arm is used to retain the cutting teeth to the arms.

### CROSS-REFERENCE TO RELATED APPLICATIONS

This is a continuation-in-part of U.S. patent application Ser. No. 09/330,573 filed on Jun. 11, 1999. Application Ser. No. 09/330,573 is pending.

### BACKGROUND OF THE INVENTION

1. Field of the Invention

This invention relates to devices used to cut slots, grooves, hollow cuts and the like in surfaces. The new device provides a simple means to attach and replace cutter teeth used on cutting tools.

2. Description of Related Art

There are currently in use various cutting tools and blades for use in providing hollow cuts in surfaces of materials such as plastic, wood, bamboo, metal and the like. Where rotational cutting tools are used which require a particular quality of hardness and abrasiveness, the cutting tool often includes cutter teeth of a material other than the tool support structure of metal. One such tooth material is carbide. The common means to attach carbide teeth to the metal support structure is to solder, weld or braise the carbide teeth to the metal.

This type of cutting tooth is disclosed in U.S. Pat. No. 5,261,306, Issued on Nov. 16, 1993. In this invention the cutting tooth is comprised of a steel or similar metal support to which a cutting component or carbide cutting tip is braised or otherwise attached. The support element is required for purposes of threadable attachments to tooth backing mounts. Specifically the use of a bolt to pass through the backing mount to thread into the support element is disclosed. This particular structure is necessary to support the carbide tip. The two element tooth requires additional manufacturing process to fabricate the tooth. It can be seen that a device that only requires a single material, for example, carbide, is needed for ease and economy of tooth manufacture and replacement.

Use of soldering, welding or braising of carbide teeth directly to the cutting tool structure does not allow for ease of replacement of damaged teeth. This can be an expensive operation for rotating blades, which may have multiple teeth thereby increasing cost of disposal. The user of such cutting tools must pay the cost for removal of damaged teeth and welding of replacements if such is even feasible depending on the damage. The alternative is to discard the entire tool and replace it. Although such tools may be manufactured relatively inexpensively, there may be significant replacement cost for high usage applications.

Various cutting tools also exist which use fasteners such as screws to retain the cutting teeth on the blade. However, such cutting tools only have one cutting edge as a support structure, i.e., a support surface of the blade, that is required generally opposite the tooth cutting edge to withstand the cutting forces experienced when using the cutting tool. This structural support requirement for such cutting tools prevents the use of a double cutting edge tooth for use in for example cutting a 60-degree groove in a surface.

Other more complicated combinations of cutting teeth with screw fastening attachments are represented by U.S. Pat. No. 4,667,713, Issued on May 26, 1987. Again in this disclosure the replacement part of the device is a tooth having a knife and a knife holder that is then mounted to the clipper head. In this instance the screws used to fasten the elements do not pass through the knife or knife holder in a generally perpendicular relationship to the front surface. The disclosed structure is very complicated as compared to a single element tooth to mount directly to the clipper head.

The present invention provides a simple method to attach single composition cutter teeth to the cutting tool blade such that damaged teeth may be easily replaced. The blade has keyed locations for the teeth, which properly align and structurally support the attached teeth in use for the forces of cutting encountered. In the preferred embodiment the teeth are attached by the use of screws. The teeth may be of any desired shape to make hollow cuts in a surface.

### SUMMARY OF THE INVENTION

One object of the present invention is ease of attachment and replacement of cutting teeth on cutting blades. Another object is proper alignment and structural support of cutting teeth attached to cutting blades. A further object is structural integrity and support for single composition cutting teeth.

In accordance with the description presented herein, other objectives of this invention will become apparent when the description and drawings are reviewed.

### BRIEF DESCRIPTION OF THE DRAWING

FIG. 1 illustrates a side elevation view of the cutting tool with blade and cutting teeth.

FIG. 2 illustrates a section view taken at 2-2.

FIG. 3 illustrates a partial view of the blade and a cutting tooth taken at 3-3.

FIG. 4 illustrates a front elevation view of a cutting tooth showing the cutting surface.

FIG. 5 illustrates a side section view of the cutting tooth taken at 5-5.

FIG. 6 illustrates a section view taken at 6-6.

FIG. 7 illustrates a bottom view of the tooth.

FIG. 8 illustrates an alternate shape cutting tooth.

FIG. 9 illustrates a partial view of the blade and a cutting tooth with key groove and key projection location reversed.

### DESCRIPTION OF THE PREFERRED EMBODIMENT

The cutting tool in the preferred embodiment has a rotational blade with multiple arms on which cutting teeth are attached. In the preferred embodiment the arms include a key projection or ridge shaped to engage a key groove formed in the cutting teeth. However, this structure may be reversed with the key projection formed on the cutting teeth and the key groove formed in the arms as illustrated in FIG. 9. There is also a threaded circular aperture in each arm and a corresponding aperture in the teeth for use of a screw to attach each tooth to an arm.

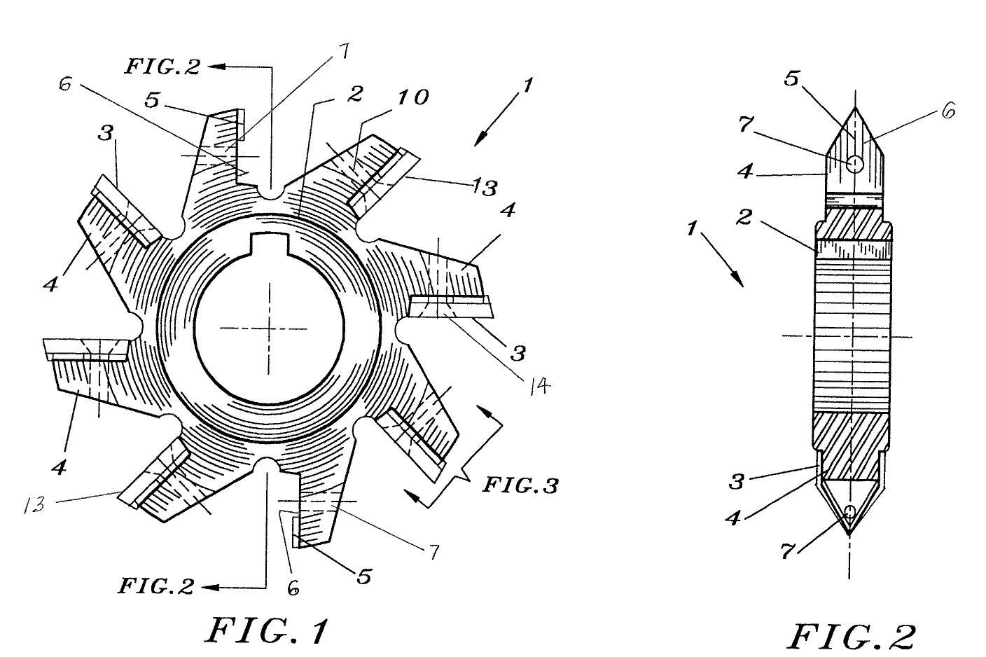

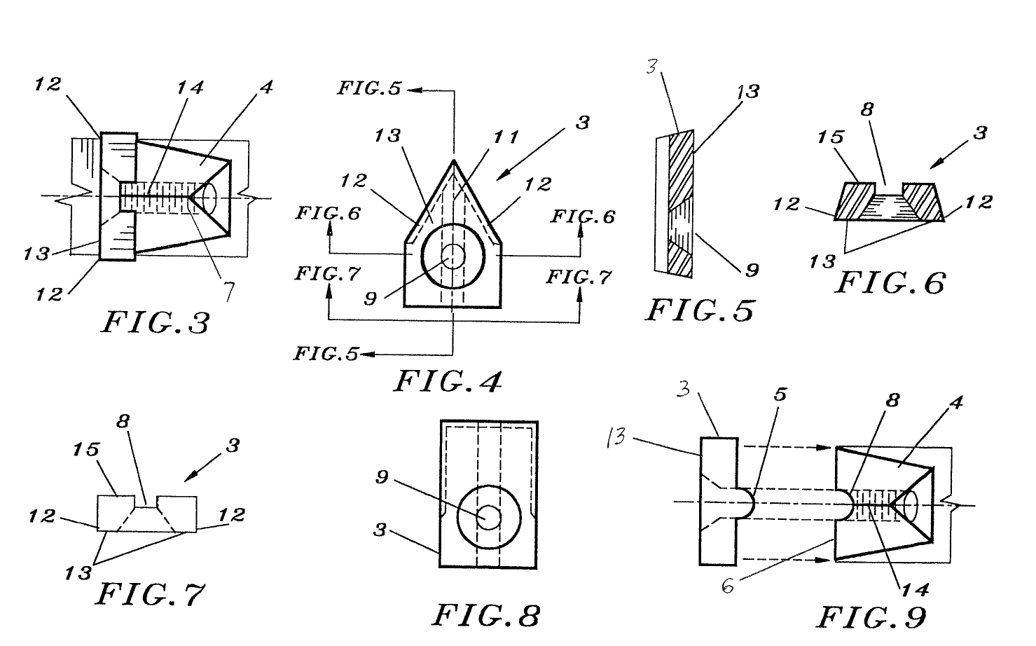

Referring to FIGS. 1 through 7, the cutting tool (1) has a rotational support structure or blade (2) to which cutting teeth (3) are attached. Cutting blades (2) such as for the preferred embodiment are normally of a steel material and are intended to be mounted or attached to a rotational spindle of a power tool. The blade (2) has a plurality of arms (4) to which the cutting teeth (3) are actually attached. The dimensions of the blade (2) and arms (4) are a function of the particular power tool to be used, the cutting to be done and the material to be cut. As illustrated in FIG. 1, rotation would be clockwise. Examples of blades (2) with welded or braised teeth exist in the art. A commonly used tooth material is carbide.

Arms (4) have key projections (5), illustrated as raised rectangular, ridges located on the front or cutting face (6) of the arm (4). There is also a mounting aperture (7) in the cutting face (6), shown penetrating the entire arm (4) for the preferred embodiment. For illustrative purposes of attachment of cutting teeth (3), the mounting aperture (7) is circular in cross-section and threaded.

Each cutting tooth (3) is shaped to make a particular hollow cut in a surface. For illustration of the preferred embodiment a shape to provide a 60 degree cut is shown; however, as illustrated in FIG. 8, other shapes may be used. With current art, using carbide cutting teeth, which are attached by a fastener, a 60 degree groove cannot be made as cutting teeth may only have one cutting edge at a 30 degree angle as compared to the instant invention. This arises because the current art tooth must have blade or arm support structure opposite the cutting edge to withstand the forces created in the cutting process unless a solder or welding structure is used. This structure may be provided by use of a two element combination tooth.

In the instant invention the cutting tooth (3) has a key groove (8) in the back surface (15) and attachment aperture (9) approximately perpendicular to the cutting surface (13) through which a fastener (10) is inserted to attach the cutting tooth (3) to an arm (4). The use of the key projection (5) mating with the key groove (8) and use of a fastener eliminate the need for welding or braising of teeth. A single composition material tooth (3) of for example carbide may be used. The key projection (5) and key groove (8) provide structural support for the forces experienced by the cutting teeth (3) in use along the longitudinal centerline (11) thus allowing for multiple cutting edges (12) as compared to current art cutting teeth which use fasteners. Through experiment it has been found that a tolerance for the key groove and key protrusion of + or −0.100 inches at surface interfaces gives good results.

In the preferred embodiment the cutting tooth (3) has an attachment aperture (9) that is countersunk in its cutting surface (13) for receipt of the head of a screw (14). It has been found by experiment with the dimensions and tolerances of a blade (2) as illustrated, that a screw (14) has sufficient clearance for insertion between two adjacent arms (4) and for tightening with a ball Allen screw device (not shown).

The cutting tooth (3) is illustrated with cutting edge (12) tapered at approximately a 10 degree angle inward away from the cutting surface (13). This is a matter of choice as understood in the art and angles of 0 degree, 15 degree, or larger in both positive and negative values and the like may be used as appropriate.

An alternate embodiment wherein the key projection (5) is formed on the cutting tooth (3) and the key groove (8) is formed in the arm (4) is illustrated in FIG. 9.

While the invention has been particularly shown and described with respect to the illustrated and preferred embodiments thereof, it will be understood by those skilled in the art that the foregoing and other changes in form and details may be made therein without departing from the spirit and scope of the invention.

I claim:

1. A device for attachment to a power tool for use in making hollow cuts in a surface comprising:
a blade having a plurality of arms protruding radially therefrom wherein a cutting face disposed on each arm having a key projection and each arm having a threaded mounting aperture defined therein;
a plurality of cutting teeth each having a key groove in a back surface and an attachment aperture formed therein approximately perpendicular to a cutting surface wherein the cutting surface having a recess therein coaxial with the attachment aperture;
each cutting tooth is attached to the cutting face of one of the arms by mating the key projection and the key groove and by inserting a fastener in the attachment aperture and threading the fastener into the mounting aperture; and
the cutting face shaped to be approximately the size of the back surface to support the cutting tooth.

2. The device as in claim 1 wherein the key protrusion is of generally rectangular form with the longitudinal axis extending radially along the arm and the key groove being correspondingly rectangular in form and oriented generally along a longitudinal centerline of the cutting tooth.

3. The device as in claim 1 wherein the fastener is a hex head screw for mating with the mounting aperture having a threadable means for attachment therein.

4. The device as in claim 1 wherein the tolerance between the key projection and the key groove mating surfaces is between +0.100 and −0.100 inches.

5. The device as in claim 1 wherein the cutting teeth are of a single composition material.

6. The device as in claim 5 wherein the single composition material is carbide.

7. The device as in claim 1 wherein the cutting teeth are comprised of a single element.

8. A device for attachment to a power tool for use in making hollow cuts in a surface comprising:
a blade having a plurality of arms protruding radially therefrom wherein a cutting face disposed on each arm having a key groove and each arm having a threaded mounting aperture defined therein;
a plurality of cutting teeth each having a key projection in a back surface and an attachment aperture formed therein approximately perpendicular to a cutting surface wherein the cutting surface having a recess therein coaxial with the attachment aperture;
each cutting tooth is attached to the cutting face of one of the arms by mating the key projection and the key groove and by inserting a fastener in the attachment aperture and threading the fastener into the mounting aperture; and
the cutting face shaped to be approximately the size of the back surface to support the cutting tooth.

9. The device as in claim 8 wherein the cutting teeth are of a single composition material.

10. The device as in claim 9 wherein the single composition material is carbide.

11. The device as in claim 8 wherein the cutting teeth are comprised of a single element.
